(19) United States
(12) Patent Application Publication
(10) Pub. No.: US 2019/0277214 A1
(43) Pub. Date: Sep. 12, 2019

(54) SYSTEM AND METHOD FOR BOOSTED NON-LINEAR IGNITION COIL

(71) Applicant: Diamond Electric Mfg. Corporation, Eleanor, WV (US)

(72) Inventors: Albert Anthony Skinner, Waterford, MI (US); Salah Derrouich, Colmar-Berg (LU); David Langley, Brighton, MI (US)

(73) Assignee: Diamond Electric Mfg. Corporation, Eleanor, WV (US)

(21) Appl. No.: 16/280,431

(22) Filed: Feb. 20, 2019

Related U.S. Application Data
(60) Provisional application No. 62/641,771, filed on Mar. 12, 2018.

(51) Int. Cl. F02D 41/06; H01F 38/12; F02P 3/04; F02P 5/15

(52) U.S. Cl. CPC F02D 41/064; F02P 5/1506; F02P 3/0414; H01F 38/12

(57) ABSTRACT

A system and/or method for a boosted non-linear coil includes an ignition coil including a first primary winding, a second primary winding and a secondary winding. A control circuit connects with the ignition coil, the control circuit including a logic device, a first switch connected with the logic device and the first primary winding and a second switch connected with the logic device and the second primary winding. The logic device controls a determined time for switching the first switch and for switching the second switch.

### CROSS-REFERENCE TO RELATED APPLICATIONS

This application claims the benefit of U.S. Provisional Patent Application No. 62/641,771, filed on Mar. 12, 2018, which is incorporated by reference herein in its entirety.

### BACKGROUND

An ignition coil (also called a spark coil) is an induction coil in an vehicle's ignition system that transforms the battery's low voltage to the thousands of volts needed to create an electric spark in the spark plugs to ignite the fuel. Modern engines have increased levels of air-fuel mixture motion. Many systems include two ignition coils alternatively firing to try to yield a constant high secondary current over a time period. These systems can require a way to block the output of one ignition coil to the other, e.g., a diode, can include complex algorithms and can yield switch loss in the drivers each time the ignition coils are switched. Also, the higher the frequency of the switching, and related current rise, the higher the eddy and hysteresis losses in the coils iron.

### SUMMARY

In one aspect, a system and/or method for a boosted non-linear coil includes an ignition coil including a first primary winding, a second primary winding and a secondary winding. A control circuit connects with the ignition coil, the control circuit including a logic device, a first switch connected with the logic device and the first primary winding and a second switch connected with the logic device and the second primary winding. The logic device controls a determined time for switching the first switch and for switching the second switch.

This Summary is provided merely for purposes of summarizing some example embodiments to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages of various disclosed embodiments will become apparent from the following detailed description taken in conjunction with the accompanying drawings which illustrate, by way of example, the principles of the described embodiments.

### BRIEF DESCRIPTION OF DRAWINGS

FIG. 1 is a block diagram of an example ignition control environment.

FIG. 2A is graph and FIG. 2B a circuit of an example permeance of a non-linear ignition coil.

FIGS. 3A-F are graphs of example waveform comparison between boosted coil types.

FIG. 4 is a circuit diagram of an exemplary circuit for controlling boost.

FIGS. 5A-D are example timing diagrams for driving the ignition coil in different modes, e.g., via the control circuit.

FIG. 6 is diagram of an example ignition coil.

### DESCRIPTION

Systems and methods provide for a boosted non-linear coil. In some examples, a boosted ignition coil can utilize non-linear magnetics with a dual primary, single secondary ignition coil. Permeance increases significantly as the flux approaches zero. A problem can occur in that the primary current rises fairly quickly to a level pushing flux in an opposite direction, so that when boost is ended a secondary current flow from energy can be stored as a negative flux, resulting in an alternating current (AC) system. A system, method, circuit and/or ignition discussed below can help address this problem, providing for a non-linear coil direct current (DC) output. This can allow for the use of blocking diodes, can eliminate increased plug costs and provide longer boost, e.g., about 3 to 5 milliseconds (ms), to air-fuel mixture motions.

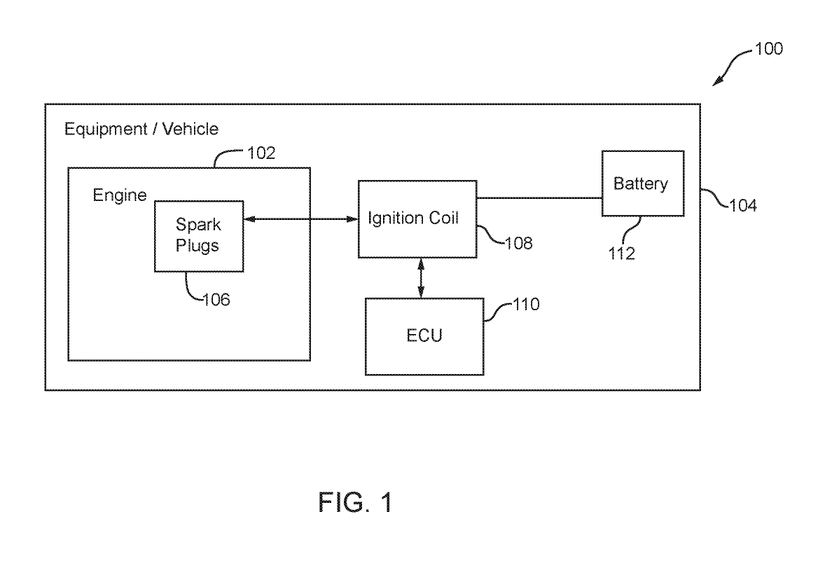

FIG. 1 is block diagram of an example ignition coil control environment 100. The environment 100 can include an engine 102, e.g., for supplying power to equipment 104, for example vehicles, generators, etc. Spark plugs 106 ignite an air-fuel mixture in the engine cylinders for providing power the engine 102. One or more ignition coils 108 send the spark plugs 106 the voltage needed to create an electric spark. An engine control unit (ECU) 110, or other type of equipment controller, can send an electronic spark timing (EST) signal to the ignition coils 108 to control a supply of current to the spark plugs 106. The ECU 110 can include, or have access to, a logic device and a memory, where the memory stores machine readable instructions that when executed by the logic device performs control logic described herein. A battery 112 connects with the ignition coil 108 to provide power to the ignition coil 108.

Modern engines 102 can have increased levels of air-fuel mixture motion, e.g., a higher velocity at gap. Since a plasma voltage is inversely proportional to the current, higher current yields a lower voltage to sustain the plasma. The voltage is also proportional to the length of the plasma channel, so a higher current allows the plasma to be stretched further. The more the plasma is stretched the higher the surface area to transfer heat to the air-fuel mixture. Also, the higher the current the higher the temperature of the plasma. Diamond Electric models can calculates the length, diameter and temperature of the plasma. This allows the surface area and temperature to be calculated and a relative term, in the units of ° K−cm\hat{ }2−ms, to be used to compare ignition systems capability to transfer heat to the mixture. For a convection coefficient (W−°k/m\hat{ }2), multiplying the term by the answer provides the thermal energy in Joules. Since there is no reason to suspect the convection coefficient to change based on the discharge characteristics of the ignition coil, the term can be sufficient to compare systems.

Secondary current is limited, however, to minimize plug wear. High secondary currents, e.g., greater than 140 mA, can boil even the most robust cathode materials, e.g., iridium. Modeling outputs show that the current remaining high allows for more thermal energy to be transferred to the air-fuel mixture. Since the desired time of combustion is when the coil is timed to fire, allowing the first arc/plasma to stretch out as far as possible should yield the best system for reliably igniting the mixture. An example implementation of boost is described in U.S. Pat. No. 5,886,476, e.g., with regard to a dual primary, single secondary ignition coil, the entirety of which is incorporated by reference herein. Typically, primary current can rise quickly to a level pushing flux in an opposite direction, so when the boost ends, secondary current flows from energy stored in negative flux level, resulting in an alternating current (AC) system. A blocking diode cannot be used, and current in both directions can drive up a cost of the spark plugs 106 as both electrodes become the cathode. Therefore, the ignition coil 108 improves on aspects of the '476 ignition coil, with a system that includes a high dL/di as I approaches zero. The highly non-linear inductance in the ignition coil 108 increases sharply as flux (e.g., current) approaches zero. This limits increase in primary current and increases time that boost can be applied before crossing flux=0 point. Therefore allowing a direct current (DC) output. This allows the use of a blocking diode, eliminates increased plug cost, and/or longer boost increases robustness to air-fuel mixture motion, e.g., increases current at the time the arc is being stretched.

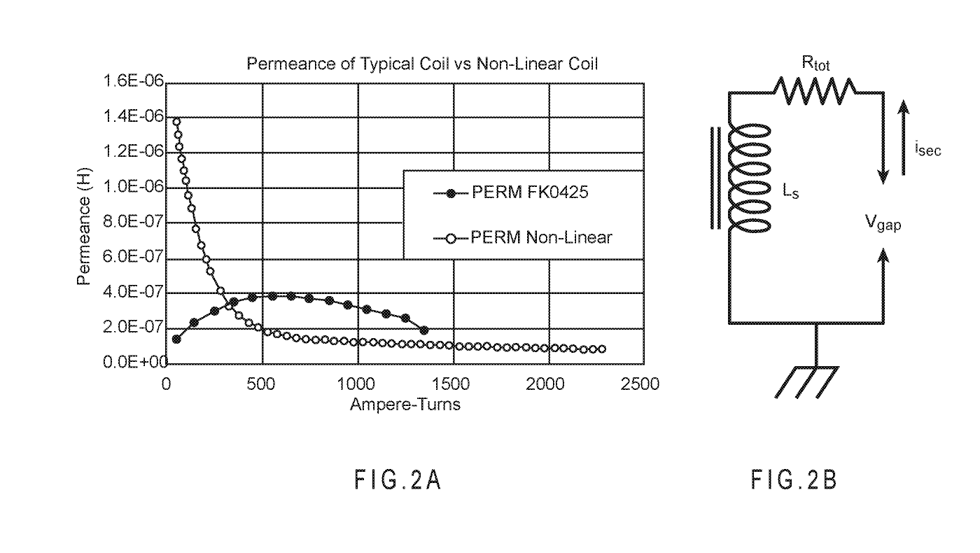

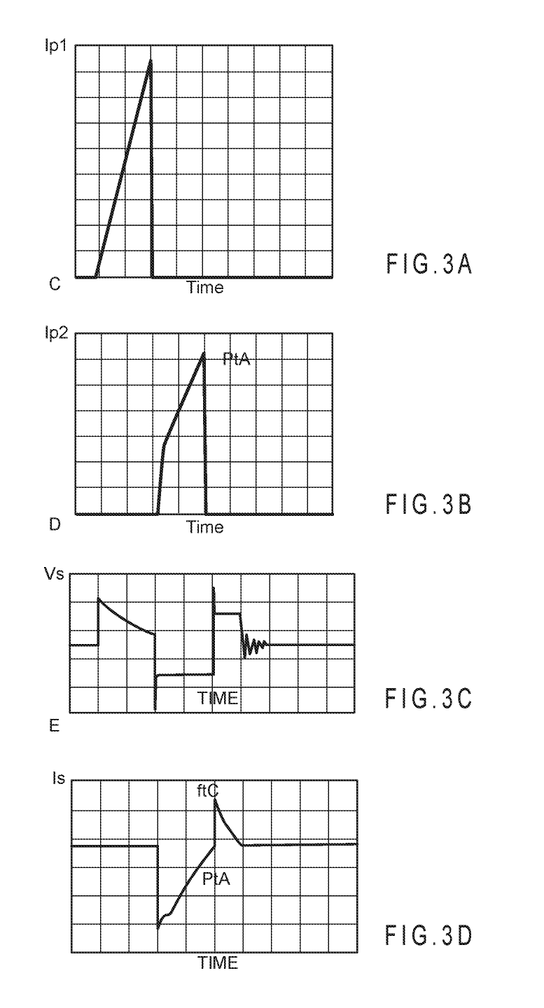

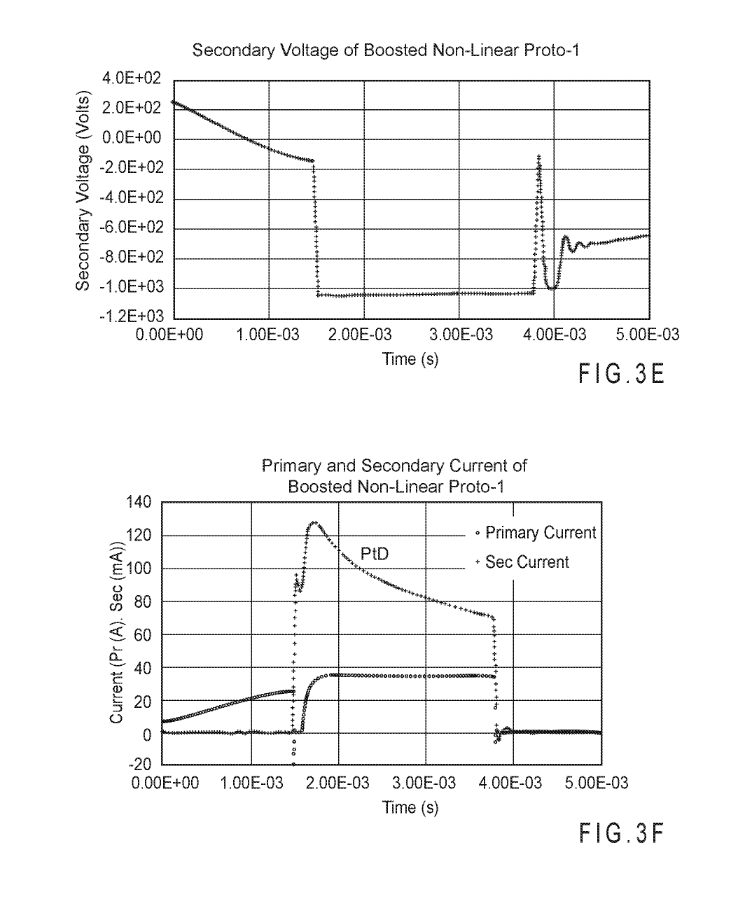

FIG. 2A is graph and FIG. 2B a circuit of an example permeance of a non-linear ignition coil. As the magnetomotive force (mmf—net currents coupled to magnetic structure) approaches zero with a coil, permeance decreases, requiring higher dipri/dt (Pt.A FIG. 3B) to sustain gap voltage, or increasing disec/dt results (Pt.B FIG. 3D). This allows flux to easily cross zero and drive current in opposite direction when primary coil two is turned off (Pt. C FIG. 3D). To minimize risk the charge time of the first coil must be limited so that the turn on time of the coil (time “make voltage” appears) does not occur before the piston compresses the air-fuel mixture sufficiently to increase the breakdown voltage. Limiting the permeance/energy capability of the first coil can also limit how long the ignition coil 108 can be boosted by coil number 2.

With a non-linear coil the high increase in permeance as flux approaches zero increases both the

$${i}_{pri} \frac{{dP}_{p}}{dt} and {P}_{p} \frac{{di}_{pri}}{dt}$$

terms in the equation below, and thus decreases di_{sec}/dt (Pt.D FIG. 3F). This results in a long amount of boost, e.g., about 2.5 msec for a first example with a 190 mm\hat{ }2 core at a 1000V load. Boost time allowable without changing current polarity is proportional to the permeability of the magnetic structure, which increases directly proportional to ignition coil core size.

$${V}_{gap} + {i}_{se c} {R}_{tot} = ( {N}_{ss} \frac{d {ψ}_{s}}{dt} + {N}_{SP} \frac{d {ψ}_{p}}{dt} )$$

$$\frac{{di}_{se c}}{dt} = ( {V}_{gap} + {i}_{se c} {R}_{tot} - {N}_{SP} \frac{d {ψ}_{p}}{dt} ) / {L}_{s}$$

$$\frac{{di}_{se c}}{dt} = ( {V}_{gap} + {i}_{se c} {R}_{tot} - {N}_{SP} {N}_{p} \frac{d {P}_{p} {i}_{pri}}{dt} ) / {L}_{s}$$

Where, ψₛ=N_{S}P_{S}i_{sec} is flux produced by secondary turns, ψₚ=NₚPₚiₚᵣᵢ flux produced by primary turns.

FIGS. 3A-F are graphs of example waveform comparison between boosted coil types. FIG. 3A is a graph of an example current response over time of primary coil/winding one, FIG. 3B is an example current response of primary coil/winding two, FIG. 3C is an example voltage response of the secondary coil/winding, and FIG. 3D is an example current response of the secondary coil/winding, for a double primary, single secondary, linear coil. In the unmodified system, FIG. 3C shows a positive voltage at the first peak, and in FIG. 3D the current switches from negative to positive. In the modified system, FIG. 3E is a graph of an example secondary voltage over time, and FIG. 3F is a graph of an example primary and secondary current over time, for a boosted, non-linear coil. The secondary current remains substantially high for the non-linear magnetic ignition coil 108, in which inductance in the ignition coil 108 increases sharply as flux approaches zero (FIG. 3F Pt.D), instead of including the change from positive to negative current (FIG. 3D PT.C) for a linear coil, which avoids the AC effect. The high secondary current can be efficient in delivering thermal energy to the air-fuel mixture.

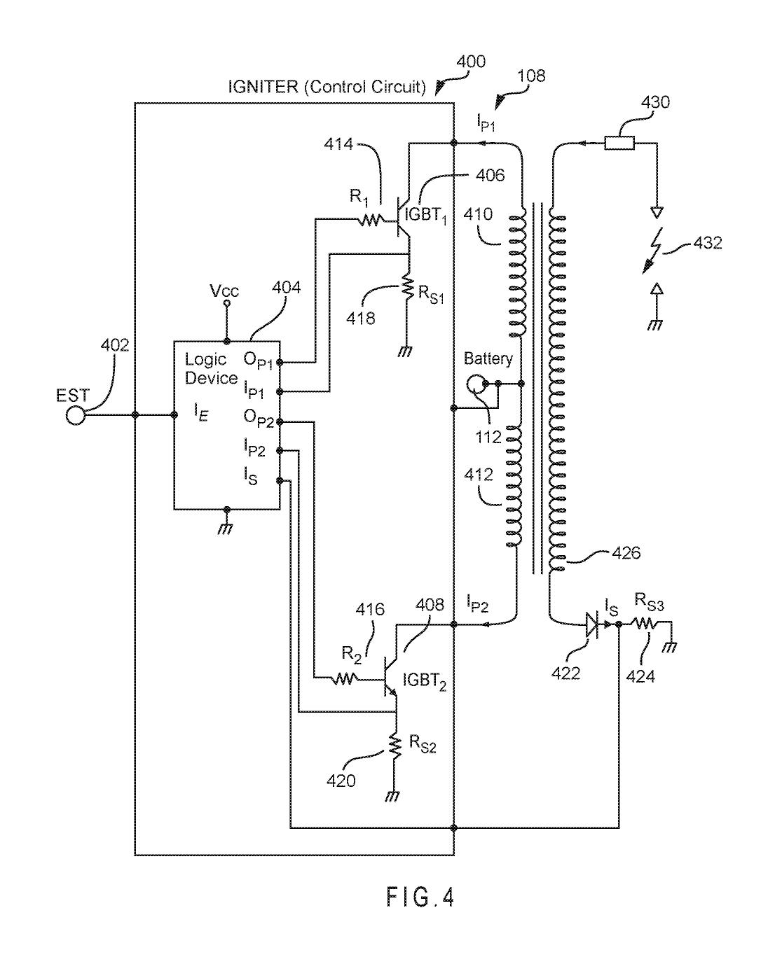

FIG. 4 is a circuit diagram of an exemplary control circuit 400 for controlling boost of the ignition coil 108. The control circuit 400 can be integrated together with electronics of the ECU 110 or be integrated separately from the ECU 110 and connected with the ECU 110, e.g., to receive EST signal 402 from the ECU 110. The control circuit 400 includes a logic device 404, or other logic circuit, connected with a first switch 406 and a second switch 408, e.g., drivers. In some examples, the logic device 404 includes one or more of a processor, a logic circuit, a complex programmable logic device (CPLD), a field-programmable gate array (FPGA), an application-specific integrated circuit (ASIC), etc. In some examples, the logic device 404 can execute machine readable instructions to perform the logic discussed herein. In some examples, the switches are transistors, e.g., insulated-gate bipolar transistors (IGBT). Additionally, other types of transistors can be used. A collector of the first switch 406 connects with a first primary winding 410 of the ignition coil 108, and a collector of the second switch 408 connects with a second primary winding 412 of the ignition coil 108. The battery 112 connects with the first primary winding 410 and the second primary winding 412 of the ignition coil 108 to provide power to the ignition coil 108.

A gate of the first switch 406 connects with the logic device 404 in series with resistor R1 414 to receive output signal OP1 from the logic device 404, and an emitter of the first switch 406 connects with the logic device 404 in parallel with resistor RS1 418 to provide current signal IP1 to the logic device 404. A gate of the second switch 408 connects with the logic device 404 in series with resistor R2 416 to receive output signal OP2 from the logic device 404, and an emitter of the second switch 408 connects with the logic device 404 in parallel with resistor RS2 420 to provide current signal IP2 to the logic device 404. The logic device 404 also receives signal IS from the secondary winding 426 in parallel with diode 422 and resistor RS3 424. Some non-limiting examples of R1 and R2 is 300 Ohms, and Rs1 , Rs2 and Rs3 is 20 m Ohm. The blocking diode 422 can be positioned in series with the secondary winding 426, on either the high voltage side or the low voltage side (shown). The secondary winding 426 can connect with an optional suppressor 430 in series with spark plug 432, which provides the spark to the air-fuel mixture.

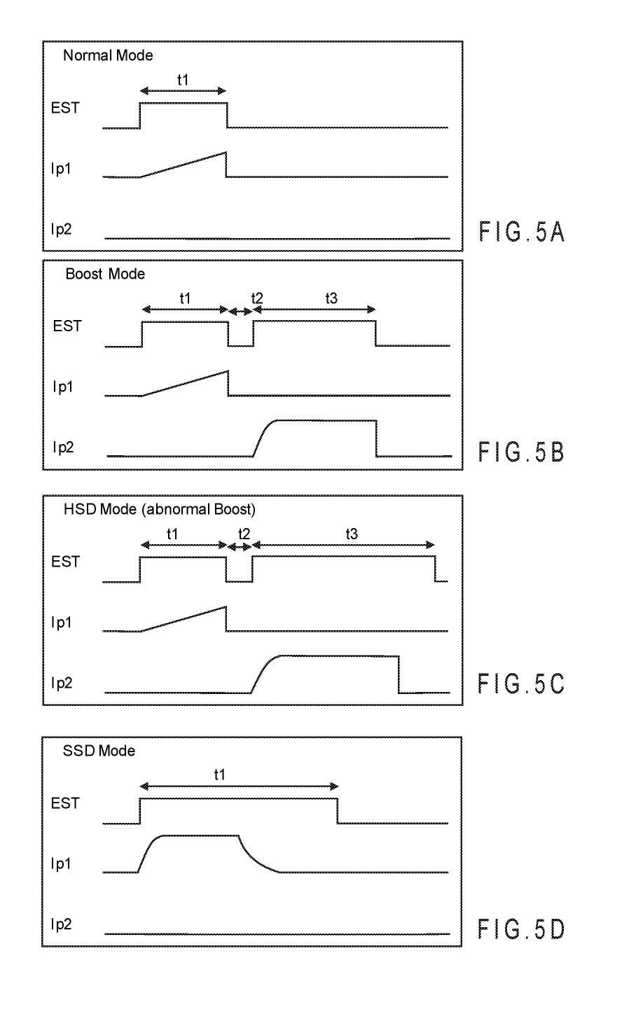

FIGS. 5A-D are example timing diagrams for driving the ignition coil 108 in different modes, e.g., via the control circuit 400. FIG. 5A provides an example normal mode, FIG. 5B provides an example boost mode, FIG. 5C provides an example hard shut-down mode (HSD), and FIG. 5D provides an example soft shut-down mode (SSD). The logic device 404 analyzes the EST signal 402, I_{E}, to determine when to trigger the first switch 406 and the second switch 408. Time t₁ is the charge time for the first primary winding 410, time t₂ is the delay time before boost signal t₃ is sent, e.g., between about 30 μs and about 400 μs, and time t₃ is the charge time for the second primary winding 412, e.g., boost. During boost, the logic device 404 can provide high current, for example, at the time the arc of the spark is being stretched.

For example, during normal mode in FIG. 5A, the logic device 404 sends signal O_{P1} to the first switch 406 during time t₁ to close the first switch 406 to connect with ground to charge the first winding 410 via current I_{P1}, e.g., about 25-30 Amps, and the second switch 408 is open, so no current I_{P2} is flowing through the second primary winding 412. During boost mode in FIG. 5B, the logic device 404 sends signal O_{P1} to the first switch 406 during time t₁ to close the first switch 406 to connect with ground to charge the first winding 410, delays time t₂, and then sends signal O_{P2} to the second switch 408 during time t₃ to close the second switch 408 to connect with ground to charge the second primary winding 412 via current I_{P2}. When the switch 406 is open, current I_{P1} is zero, and when switch 408 is open, current I_{P2} is zero. By the logic device 404 monitoring current I_{P1}, the logic device 404 can trigger SSD mode when needed, e.g., if time t₁ stays high for a long period of time, and provide for a slow drop in current I_{P1}, e.g., no spark, to avoid overheating. The logic device 404 can adjust the voltage at the gate of the first switch 406 to provide for the slow opening of the first switch 406 to accommodate soft shut off of the current I_{P1}. By the logic device 404 monitoring current I_{P2}, the logic device 404 can trigger HSD mode when needed, e.g., time t₃ has been high for a long period of time, and provide for a sharp shut off of the flow of current I_{P2}. Times t₂ and t₃ are variable and can be adjusted by a manufacturer, e.g., based on an implementation.

In some examples, the ECU 110 can send the control circuit 400 two independent EST inputs. The control circuit 400 can establish a blanking period, e.g., about 50 μsec to 100 μsec, after an EST signal 402 is received. After this period, the logic device 404 can interpret any EST signal 402 received on that line within a pre-determined period, e.g., about 3 ms to 5 ms, as a boost signal to turn on the switch 408 for the second primary winding 412.

In some examples, the logic device 404 can shut down current flow I_{P1} and/or I_{P2} based on the detected misfires, e.g., detected current and/or current over time on either the primary or secondary side of the ignition coil 108. In some examples, the logic device 404 can monitor secondary winding current Iₛ, e.g., to control boost and/or detect misfires. For examples, a detected secondary current Iₛ of zero can indicate a misfire. In some examples, real-time secondary winding current Iₛ can be sent to the ECU 110 for further processing, e.g., during cold engine, low battery, high velocity modes, etc. In some examples, the logic device 404 can turn off boost after secondary winding current Iₛ achieves a determined limit, e.g., 80 milliamps. In some examples, the logic device 404 can maintain boost after t3 has completed, based on the detected secondary current Iₛ, e.g., which indicates that the flame is still active. In some examples, the logic device 404 can turn off the boost upon detection that secondary winding voltage is increasing, e.g., to extend spark plug life.

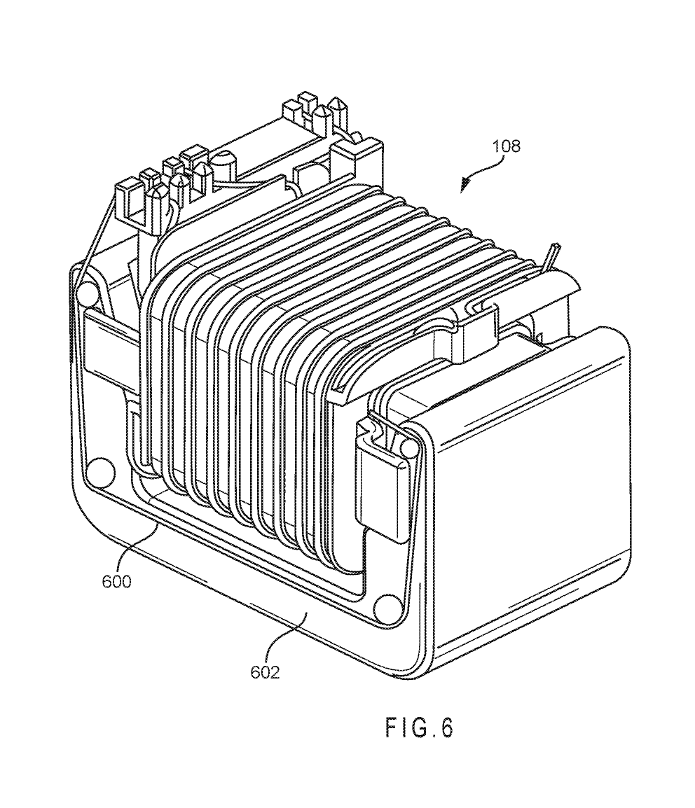

FIG. 6 is diagram of an example ignition coil 108. The ignition coil 108 can include a dual primary winding, e.g., first primary winding 410 and second primary winding 412, in which each respective primary windings 410, 412 can be independently energized to establish magnetic fields of opposite polarity, e.g., as in U.S. Pat. No. 5,886,476, which is incorporated by reference herein. The ignition coil 108 can include a powdered (composite) iron core surrounded by the windings 410, 412, which provide an open magnetic circuit. The energy that is stored in the magnetic field of the core is transferred to the spark plug 106, 432. The powdered iron core combined with the second primary winding 412 can provide high constant current, without the need for a pulse circuit or high voltage blocking diode. The first two layers of the ignition coil 108 can be wound as known. The termination of the second layer can start the third layer. This point can be connected to B+ so when the winding is continued, the resulting current is in the opposite direction. The end of the third layer can spiral back to the ignition coil's 108 low voltage end. To avoid an increase in size of the ignition coil 108 and the mean length turn (MLT) of the second primary winding 412, a wire 600 of the second primary winding 412 can be routed along the “C” core 602 after coil assembly. The wire 600 can be terminated on an opposite end of a bobbin of the ignition coil 108.

The ignition coil 108 includes a magnetic structure coupled with the first primary winding 410, second primary 412 winding and secondary winding 426, e.g. the magnetic structure described in the '476 patent. The magnetic structure provides a sharply increasing permeability as flux in the magnetic structure approaches zero. The first primary winding 410 and the second primary winding 412 are wound to provide flux in an opposite direction and to be controlled independently, e.g., by the circuit in FIG. 4. The secondary winding 426 is activated, e.g., by the circuit in FIG. 4, after decaying flux from first primary winding ionizes spark gap and before flux from the first primary winding decays to zero.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

We claim:

1. A system for controlling ignition, comprising:
an ignition coil including a first primary winding, a second primary winding and a secondary winding;
a control circuit connected with the ignition coil, the control circuit including a logic device, a first switch connected with the logic device and the first primary winding and a second switch connected with the logic device and the second primary winding; and
where the logic device controls a determined time for switching the first switch and for switching the second switch.

2. The system for controlling ignition of claim 1, where the determined time is based on an electronic spark timing signal.

3. The system for controlling ignition of claim 2, where the logic device receives the electronic spark timing signal from an engine control unit.

4. The system for controlling ignition of claim 1, where the logic device receives a current signal from the secondary winding.

5. The system for controlling ignition of claim 4, where the logic device controls a determined time for switching the second switch based on the received current signal.

6. The system for controlling ignition of claim 1, where the logic device provides a delay time between switching the first switch and switching the second switch.

7. The system for controlling ignition of claim 1, where the logic device switching the second switch controls boost.

8. The system for controlling ignition of claim 1, where the logic device controls the first switch to provide soft shutdown of current to the first winding.

9. The system for controlling ignition of claim 1, where the logic device controls the second switch to provide hard shutdown of current to the second winding.

10. The system for controlling ignition of claim 1, where the first switch and the second switch comprise insulated-gate bipolar transistors.

11. The system for controlling ignition of claim 1, where the first primary winding and the second primary winding are terminated on opposite ends of a bobbin of the ignition coil.

12. A circuit, comprising:
a logic device;
a first switch connected with the logic device and a first primary winding of an ignition coil; and
a second switch connected with the logic device and a second primary winding of the ignition coil;
where the logic device controls a determined time for switching the first switch and for switching the second switch.

13. The circuit of claim 12, where the determined time is based on an electronic spark timing signal.

14. The circuit of claim 12, where the logic device receives a current signal from the secondary winding.

15. The circuit of claim 14, where the logic device controls a determined time for switching the second switch based on the received current signal.

16. The circuit of claim 12, where the logic device provides a delay time between switching the first switch and switching the second switch.

17. The circuit of claim 12, where the logic device switching the second switch controls boost.

18. The circuit of claim 12, where the logic device controls the first switch to provide soft shutdown of current to the first winding.

19. The circuit of claim 12, where the logic device controls the second switch to provide hard shutdown of current to the second winding.

20. A method, comprising:
controlling a first switch connected with a first primary winding of an ignition coil for a first time period;
controlling a second switch connected with a second primary winding of the ignition coil for a second time period; and
providing a delay between the first time period and the second time period.

21. The method of claim 20, where the second time period comprises boost.

22. The method of claim 20, further comprising receiving a current signal from a secondary winding of the ignition coil.

23. The method of claim 22, further comprising controlling at least one of the first switch and the second switch based on the received current signal.

24. A system for controlling ignition, comprising:
an ignition coil including a magnetic structure coupled with a first primary winding, a second primary winding and a secondary winding; and
where the magnetic structure provides a sharply increasing permeability as flux in the magnetic structure approaches zero;
where the first primary winding and the second primary winding are wound to provide flux in an opposite direction and controlled independently;
where the secondary winding is activated after decaying flux from first primary winding ionizes spark gap and before flux from the first primary winding decays to zero.

25. The system of claim 24, further including a control circuit connected with the ignition coil, the control circuit including a logic device, a first switch connected with the logic device and the first primary winding and a second switch connected with the logic device and the second primary winding; and
where the logic device controls a determined time for switching the first switch and for switching the second switch.
